(19) United States
(12) Patent Application Publication
(10) Pub. No.: US 2024/0275485 A1
(43) Pub. Date: Aug. 15, 2024

(54) AUTHENTICATION WITH INFRARED LIGHT FOR DIGITAL KEYS

(71) Applicant: INTERNATIONAL BUSINESS MACHINES CORPORATION, ARMONK, NY (US)

(72) Inventors: Jonathan Orozco Cervantes, Tlajomulco de Zúñiga (MX); ALAN VERDUGO MUÑOZ, Guadalajara (MX); ANDRES ALEJANDRE JIMENEZ, Zapopan (MX); Humberto Orozco Cervantes, Tonalá (MX)

(21) Appl. No.: 18/108,920

(22) Filed: Feb. 13, 2023

(51) Int. Cl. H04B 10/114; H04L 9/40

(52) U.S. Cl. CPC H04B 10/114; H04L 63/0807; H04L 63/083; H04L 2463/082

(57) ABSTRACT

A method for controlling access to a system based on multi-factor authentication using infrared light. The method receives a request for system authentication via a username and password. The method further detects an infrared light communication capability on a second device, and receives a digital key transmitted via infrared light from the second device. The method identifies the digital key based on a light pattern emitted by the infrared light. The method further validates the received digital key and grants system access based on the validation.

### BACKGROUND

The present disclosure relates generally to the field of cognitive computing and more particularly to data processing and controlling access to a computing device based on multi-factor authentication using infrared light.

More than ever before, our lives are tightly intertwined and defined by our electronic footprint. Everything from our financial data to our social media presence is readily accessible and subject to impact electronically. In many instances, all this sensitive information may be accessed from a single touchpoint on personal mobile devices.

In today's digital world, security is a fundamental part of our daily lives. The classic user authentication uses a username/e-mail and password. However, this method is not always secure. For example, if the user types a password on a keyboard and a “shoulder surfing” attacker observes which keys are typed, then the attacker gains knowledge of the user's access information. Another common authentication method for smartphones is drawing a pattern on the screen, but this is also susceptible to a “shoulder surfing” attack.

Nowadays, two-step authentication methods give more security to any access system. However, there is currently no multi-factor authorization that bypasses text messages or e-mail.

### BRIEF SUMMARY

Embodiments of the present invention disclose a method, a computer program product, and a system.

According to an embodiment, a method, in a data processing system including a processor and a memory, for controlling access to a system based on multi-factor authentication using infrared light is provided. The method receives a request for system authentication via a username and password. The method further detects an infrared light communication capability on a second device and transmits a digital key via infrared light from the second device. The method further validates the received digital key and grants system access based on the validation.

A computer program product, according to an embodiment of the invention, includes a non-transitory tangible storage device having program code embodied therewith. The program code is executable by a processor of a computer to perform a method. The method receives a request for system authentication via a username and password. The method further detects an infrared light communication capability on a second device and transmits a digital key via infrared light from the second device. The method further validates the received digital key and grants system access based on the validation.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method receives a request for system authentication via a username and password. The method further detects an infrared light communication capability on a second device and transmits a digital key via infrared light from the second device. The method further validates the received digital key and grants system access based on the validation.

### BRIEF DESCRIPTION OF THE DRAWINGS

FIG. 1 depicts a diagram graphically illustrating the hardware components of infrared access program computing environment 200 and a cloud computing environment, in accordance with an embodiment of the present invention.

FIG. 2 illustrates infrared access program computing environment 200, in accordance with an embodiment of the present invention.

FIG. 3 is a flowchart illustrating the operation of infrared access program 220 of FIG. 2, in accordance with an embodiment of the present invention.

### DETAILED DESCRIPTION

Cyber-attacks have increased drastically over the past years, and it seems this trend will continue into the near future. Authentication methods are one of the main defenses that help to protect sensitive information.

The classic method of user authentication, using a username/e-mail and password, is not always enough to have secure access. For example, most authentication methods require the user to perform an action, which can be replicated if a potential attacker is present while the action is performed (e.g., shoulder surfing).

However, authentication methods need to be user-friendly to be accepted by the general user base. In other words, authentication secrets should be complex enough to not be figured out by attackers while, at the same time easy to understand by regular users.

The present invention proposes a method of authenticating users with the transmission of data/passwords with infrared (IR) light utilizing a two-step authentication method.

A two-factor authentication (2FA) method, using infrared light, is particularly viable for users that do not rely on other 2FA methods such as Short Messaging Service (SMS) or e-mail. In other words, the system can just send a signal and if it receives the correct IR response from the other system, authentication would be validated.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

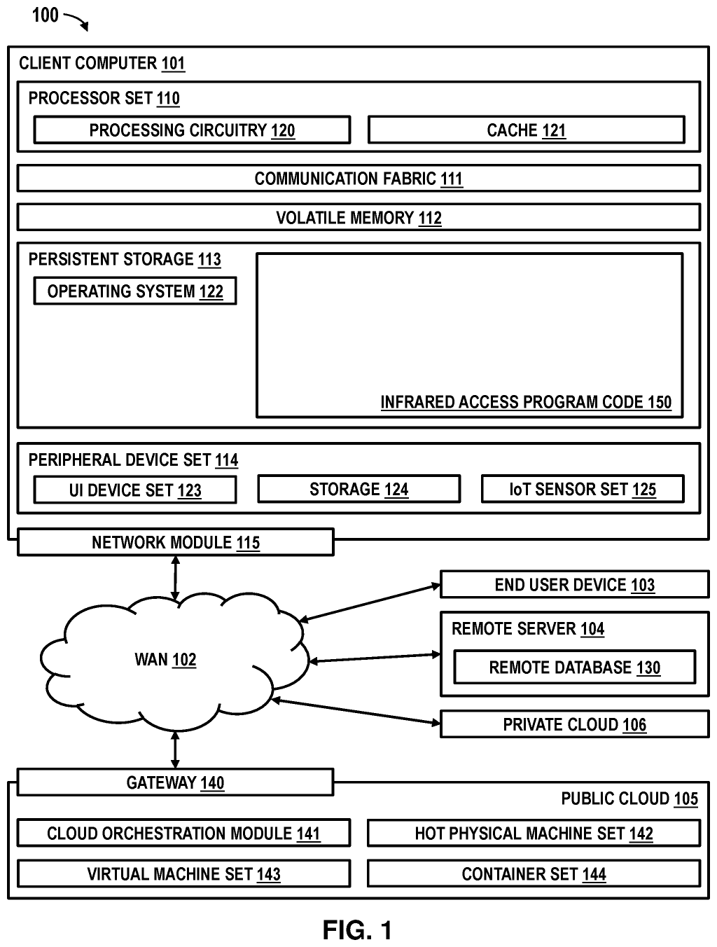

FIG. 1 depicts a diagram graphically illustrating the hardware components of infrared access computing environment 100 and a cloud computing environment in accordance with an embodiment of the present invention.

Infrared access computing environment 100 contains an example of an environment for the execution of at least some of the computer code involved in performing the inventive methods, such as infrared access program code 150. In addition to the infrared access program code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and infrared access program code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in infrared access program code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in improved electric vehicle charging scheduler program code 400 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

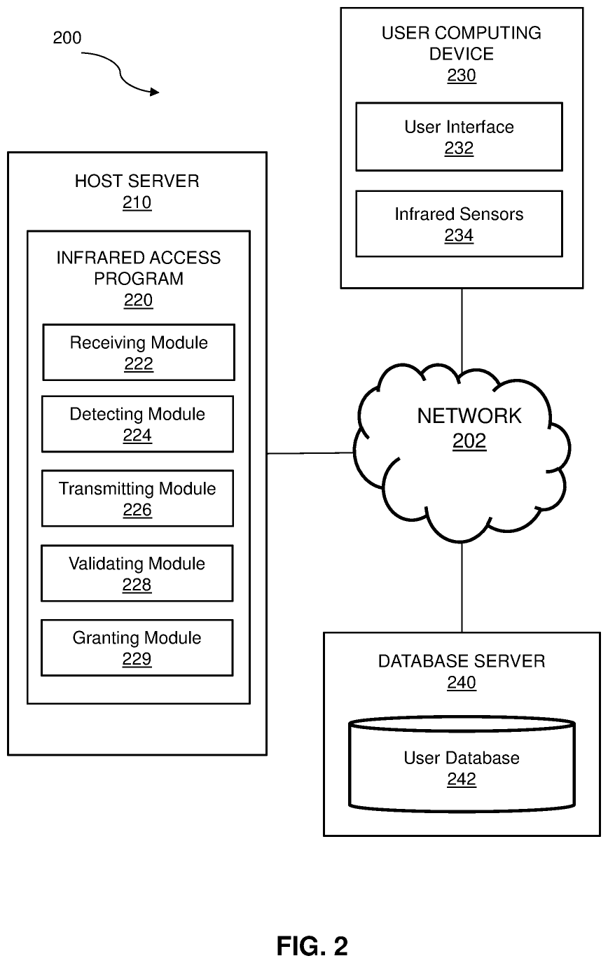

FIG. 2 illustrates infrared access computing environment 200, in accordance with an embodiment of the present invention. Infrared access computing environment 200 includes host server 210, user computing device 230, and database server 240, all connected via network 202. The setup in FIG. 2 represents an example embodiment configuration for the present invention and is not limited to the depicted setup to derive benefit from the present invention.

In an exemplary embodiment, host server 210 includes infrared access program 220. In various embodiments, host server 210 may be a laptop computer, tablet computer, netbook computer, personal computer (PC), a desktop computer, a personal digital assistant (PDA), a smart phone, or any programmable electronic device capable of communicating with user computing device 230, and database server 240, via network 202. Host server 210 may include internal and external hardware components, as depicted, and described in further detail with reference to FIG. 1. In other embodiments, host server 210 may be implemented in a cloud computing environment, as further described in relation to FIG. 1 herein. Host server 210 may also have wireless connectivity capabilities allowing it to communicate with user computing device 230, and database server 240, and other computers or servers over network 202.

With continued reference to FIG. 2, user computing device 230 includes user interface 232 and infrared sensors 234. In various embodiments, user computing device 230 may be a laptop computer, tablet computer, netbook computer, personal computer (PC), a desktop computer, a personal digital assistant (PDA), a smart phone, a server, a wearable device, or any programmable electronic device capable of communicating with host server 210 and database server 240, via network 202. User computing device 230 may include internal and external hardware components, as depicted and described in further detail with reference to FIG. 1. In other embodiments, user computing device 230 may be implemented in a cloud computing environment, as described in relation to FIG. 1. User computing device 230 may also have wireless connectivity capabilities allowing it to communicate with host server 210, database server 240, and other computers or servers over network 202.

In exemplary embodiments, user computing device 230 includes user interface 232, which may be a computer program that allows a user to interact with user computing device 230 and other connected devices via network 202. For example, user interface 232 may be a graphical user interface (GUI). In addition to comprising a computer program, user interface 232 may be connectively coupled to hardware components, such as those depicted in FIG. 1, for sending and receiving data. In an exemplary embodiment, user interface 232 may be a web browser, however in other embodiments user interface 232 may be a different program capable of receiving user interaction and communicating with other devices, such as host server 210.

In exemplary embodiments, user interface 232 may be a touch screen display, a visual display, a remote operated display, or a display that receives input from a physical keyboard or touchpad. In alternative embodiments, user interface 232 may be operated via voice commands or by any other means known to one of ordinary skill in the art.

Infrared sensors 234, in an exemplary embodiment, may be located within user computing device 230 and used for sending and receiving infrared, sometimes called infrared light. Infrared is electromagnetic radiation (EMR) with wavelengths longer than those of visible light and shorter than radio waves, and therefore invisible to the human eye.

In exemplary embodiments, infrared sensors 234 allow for a communication (i.e., sending and receiving) between one or more systems (e.g., host server 210 and user computing device 230) utilizing infrared light.

In various embodiments, infrared sensors 234 may be embedded within user computing device 230 and contain a computer processing unit (CPU), memory, and power resource, and may be capable of communicating with host server 210 and database server 240 over network 202.

In exemplary embodiments, database server 240 includes user database 242. In various embodiments, database server 240 may be a laptop computer, tablet computer, netbook computer, personal computer (PC), a desktop computer, a personal digital assistant (PDA), a smart phone, a server, or any programmable electronic device capable of communicating with host server 210 and user computing device 230, via network 202. Database server 240 may include internal and external hardware components, as depicted and described in further detail with reference to FIG. 1. In other embodiments, database server 240 may be implemented in a cloud computing environment, as described in relation to FIG. 1. Database server 240 may also have wireless connectivity capabilities allowing it to communicate with host server 210, user computing device 230, and other computers or servers over network 202.

In exemplary embodiments, user database 242 contains one or more sets of defined user profiles and associated access permissions and privileges.

While user database 242 is depicted as being stored on database server 240, in other embodiments, user database 242 may be stored on user computing device 230, host server 210, infrared access program 220, or any other device or database connected via network 202, as a separate database. In alternative embodiments, user database 242 may be comprised of a cluster or plurality of computing devices, working together or working separately.

With continued reference to FIG. 2, host server 210 includes infrared access program 220. Host server 210 may be a laptop computer, tablet computer, netbook computer, personal computer (PC), a desktop computer, a personal digital assistant (PDA), a smart phone, or any programmable electronic device capable of communicating with user computing device 230, and database server 240 via network 202.

With continued reference to FIG. 2, infrared access program 220, in an exemplary embodiment, may be a computer application on host server 210 that contains instruction sets, executable by a processor. The instruction sets may be described using a set of functional modules. In exemplary embodiments, infrared access program 220 may receive input from user computing device 230 and database server 240 over network 202. In alternative embodiments, infrared access program 220 may be a computer application on user computing device 230, or a standalone program on a separate electronic device.

With continued reference to FIG. 1, the functional modules of infrared access program 220 include receiving module 222, detecting module 224, transmitting module 226, validating module 228, and granting module 229.

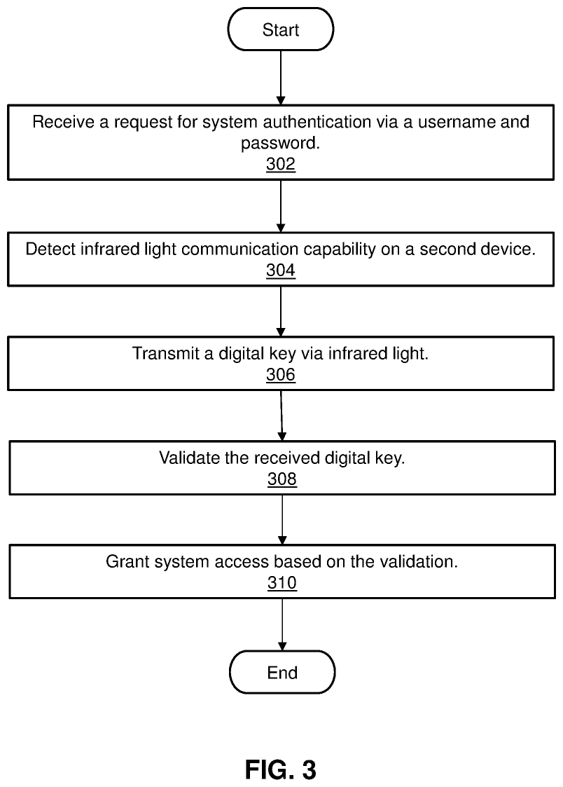

FIG. 3 is a flowchart illustrating the operation of infrared access program 220 of FIG. 2, in accordance with embodiments of the present disclosure.

With reference to FIGS. 2 and 3, receiving module 222 includes a set of programming instructions, in infrared access program 220, to receive a request for system authentication via a username and password (step 302). The set of programming instructions is executable by a processor.

In exemplary embodiments, a user performs system authentication by entering a username and password. Oftentimes, the username may be the user's e-mail address or a unique string of numbers and letters.

Customarily, a second layer of security authentication is required before granting a user access to a website or secure database. Multi-factor authentication (MFA) is an authentication method that requires the user to provide two or more verification factors to gain access to a resource such as an application, online account, or a Virtual Private Network (VPN).

Various MFA options can include SMS, a phone call to the user, and an e-mail sent to the user. Not all these MFA options are secure. SMS may contain information that is not encrypted and prone to being stolen by another user. A phone call to the user may not be the best option since it is often difficult to understand exactly what the pre-recorded computer message is saying. An e-mail sent to the user is also an insecure layer of authentication since it is visible to the human eye and prone to “shoulder surfing” by attackers in public places (e.g., coffee shops, library, etc.)

With reference to an illustrative example, Joe attempts to log-in to his online banking webpage and is required to have a multi-factor authentication process. Joe enters his unique username and password for the first layer of authentication. Joe's bank provides a few options for the multi-factor authentication which includes SMS and e-mail. However, Joe desires a more secure two-step authentication method.

With continued reference to FIGS. 2 and 3, detecting module 224 includes a set of programming instructions in infrared access program 220, to detect infrared light communication capability on a second device (step 304). The set of programming instructions is executable by a processor.

Nowadays, infrared sensors 234 are embedded in many modern smartphones, such as user computing device 230.

In exemplary embodiments, detecting module 224 can determine whether a user computing device 230 has infrared capability.

With continued reference to the illustrative example above, Joe's smartphone has infrared capabilities. As such, Joe's smartphone is used as an infrared emitter to be used as a second layer of authentication for his online bank access. This way, Joe has the advantage of not needing an extra device, like a USB key, to authenticate access and not needing to connect to an external authentication service or receiving SMS messages and/or calls.

With continued reference to FIGS. 2 and 3, transmitting module 226 includes a set of programming instructions in infrared access program 220, to transmit a digital key via infrared light (step 306). The set of programming instructions is executable by a processor.

The International Commission on Illumination has divided infrared into three (3) categories based on type of infrared wavelength: near, medium, and far.

Near infrared (NIR) is frequently used in electronics to transmit data using pulses of light, since this wavelength does not produce significant quantities of heat. The pulses of light are interpreted by the receiving device as binary data, which in turn is converted into the appropriate format required by software applications.

In exemplary embodiments, the received infrared light is NIR light, and wherein the infrared light is interpreted as binary data and transformed into a security token, secret key, or password using encryption, encoding, or plain text.

In exemplary embodiments, transmitting module 226 identifies the digital key based on a light pattern emitted by the infrared light and authenticates access based on the light pattern.

In alternative exemplary embodiments, transmitting module 226 transmits a dynamic token using infrared light.

With continued reference to the illustrative example above, Joe transmits his digital key to the online bank using has infrared device (e.g., smartphone). Joe's digital key includes a unique light pattern emitted by his smartphone, invisible to the human eye but detected by the Joe's online banking system. This second authentication step adds a strong layer of security for Joe's online banking session by preventing any potential attackers from “shoulder surfing” or stealing Joe's private access details.

With continued reference to FIGS. 2 and 3, validating module 228 includes a set of programming instructions in infrared access program 220, to validate the received digital key (step 308). The set of programming instructions is executable by a processor.

In exemplary embodiments, validating module 228 validates the received security token, secret key, or password against a previously stored role or username. For example, a previously stored role or username may be stored in user database 242.

In alternative embodiments, stored roles with associated usernames may be stored on infrared access program 220 or user computing device 230, as a separate database.

In exemplary embodiments, validating module 228 processes the received data from the transmitting device (e.g., user computing device 230) and compares/matches the received data with a central database (e.g., user database 242) to validate the accuracy of the information. If the received data is validated, then the multi-factor authentication will return a positive authentication, otherwise it will reject the authentication.

With continued reference to the illustrative example above, Joe's access permissions are saved with his online banking user profile. These access permissions may include access to Joe's personal and business credit cards, together with his wife's personal banking account information. Joe's digital key is received and validated by his online banking system.

With continued reference to FIGS. 2 and 3, granting module 229 includes a set of programming instructions in infrared access program 220, to grant system access based on the validation (step 310). The set of programming instructions is executable by a processor.

In exemplary embodiments, infrared access program 220 prompts a multi-factor authentication of a user and transmits an infrared light communication. The receiving system reads the infrared light communication, which is invisible to an unaided eye, and grants access permissions based on the read infrared light communication.

With continued reference to the illustrative example above, Joe is granted access into his online banking session, together with all of the access and privileges associated with his username. Joe's account is safe and secure with the multi-factor authentication using infrared light.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, user computing device 230, database server 240.

1. A computer-implemented method for controlling access to a system based on multi-factor authentication using infrared light, the computer-implemented method comprising:
receiving a request for system authentication via a username and password;
detecting infrared light communication capability on a second device;
receiving a digital key transmitted via infrared light from the second device;
validating the received digital key; and
granting system access based on the validation.

2. The computer-implemented method of claim 1, further comprising:
identifying the digital key based on a light pattern emitted by the infrared light; and
authenticating access based on the light pattern.

3. The computer-implemented method of claim 1, further comprising:
transmitting a dynamic token using infrared light.

4. The computer-implemented method of claim 1, wherein the received infrared light is near infrared (NIR) light, and wherein the received infrared light is interpreted as binary data and transformed into a security token, secret key, or password.

5. The computer-implemented method of claim 4, further comprising:
validating the security token, as key, or password against a previously stored role or username.

6. The computer-implemented method of claim 4, wherein the received infrared light is interpreted as binary data and transformed into a security token, secret key, or password using encryption, encoding, or plain text.

7. The computer-implemented method of claim 1, further comprising:
prompting multi-factor authentication;
transmitting infrared light communication;
reading the infrared light communication, which is invisible to an unaided eye; and
granting access permissions based on the read infrared light communication.

8. A computer program product, comprising a non-transitory tangible storage device having program code embodied therewith, the program code executable by a processor of a computer to perform a method, the method comprising:
receiving a request for system authentication via a username and password;
detecting infrared light communication capability on a second device;
receiving a digital key transmitted via infrared light from the second device;
validating the received digital key; and
granting system access based on the validation.

9. The computer program product of claim 8, further comprising:
identifying the digital key based on a light pattern emitted by the infrared light; and
authenticating access based on the light pattern.

10. The computer program product of claim 8, further comprising:
transmitting a dynamic token using infrared light.

11. The computer program product of claim 8, wherein the received infrared light is near infrared (NIR) light, and wherein the received infrared light is interpreted as binary data and transformed into a security token, secret key, or password.

12. The computer program product of claim 11, further comprising:
validating the security token, secret key, or password against a previously stored role or username.

13. The computer program product of claim 11, wherein the received infrared light is interpreted as binary data and transformed into a security token, secret key, or password using encryption, encoding, or plain text.

14. The computer program product of claim 8, further comprising:
prompting multi-factor authentication;
transmitting infrared light communication;
reading the infrared light communication, which is invisible to an unaided eye; and
granting access permissions based on the read infrared light communication.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
receiving a request for system authentication via a username and password;
detecting infrared light communication capability on a second device;
receiving a digital key transmitted via infrared light from the second device;
validating the received digital key; and
granting system access based on the validation.

16. The computer system of claim 15, further comprising:
identifying the digital key based on a light pattern emitted by the infrared light; and
authenticating access based on the light pattern.

17. The computer system of claim 15, further comprising:
transmitting a dynamic token using infrared light.

18. The computer system of claim 15, wherein the received infrared light is near infrared (NIR) light, and wherein the received infrared light is interpreted as binary data and transformed into a security token, secret key, or password.

19. The computer system of claim 18, further comprising:
validating the security token, secret key, or password against a previously stored role or username.

20. The computer system of claim 18, wherein the received infrared light is interpreted as binary data and transformed into a security token, secret key, or password using encryption, encoding, or plain text.
